(19) United States
(12) Patent Application Publication
(10) Pub. No.: US 2003/0016952 A1
(43) Pub. Date: Jan. 23, 2003

(54) Low-maintenance humidifier

(76) Inventor: David Andrew Elphee, Marshall, VA (US)

Correspondence Address: David Andrew Elphee, 6632 Carter's Run Rd, Marshall, VA, 20115, US

(21) Appl. No.: 09/901,022

(22) Filed: Jul. 10, 2001

(51) Int. Cl. F22B 1/30; H05B 3/60

(52) U.S. Cl. 392/324; 392/394

(57) ABSTRACT

A humidifier has a tank (10) and a boiling chamber (12), and a heater (14) disposed in said boiling chamber. Said humidifier tank and said boiling chamber communicate with each other near said boiling chamber's top and again near said boiling chamber's bottom, so that convection and the upward motion of steam bubbles create a circulation of water between said humidifier tank and said boiling chamber. A jet pump (38, 40, 42 & 44) is disposed in said humidifier tank so that said humidifier tank can be emptied with force, and without requiring water and minerals to pass through a drain valve. A boilover tank (54) communicates with said humidifier tank at a vertical level above the normal operating water level (48), so that if steam bubbles reach a specific height in said humidifier tank they will spill over into said boilover chamber. Controls are disposed in said boilover tank for monitoring the amount of water in said boilover tank and generating a signal.

### CROSS REFERENCE TO RELATED APPLICATIONS

Not applicable.

### BACKGROUND

1. Field of Invention

This invention relates to steam-type humidifiers.

2. Description of Prior Art

Air conditioning systems often include a humidifier to increase indoor humidity. Steam humidifiers boil water and direct the generated steam into the air stream of the air conditioning system. As the water boils, more water is added to the humidifier to keep the water level within a specific range. Any impurities in the water such as oxides of calcium and magnesium, sulfates, chlorides, and bicarbonates of sodium and potassium (to name a few), the presence of which may be unnoticeable in the water source, become concentrated as the water boils in the humidifier. Eventually these impurities precipitate out of the water, which is usually sitting stagnantly in the humidifier tank, and crystallize on the internal components. Floats become weighted and don't float properly, heating elements become coated and overheat until they burn out, drains become clogged, electrodes become coated and their function impaired, and thermal sensors (such as high temperature limit switches) become insulated from the water.

This problem has been dealt with in several ways. A mechanism may be provided to drain the humidifier and refill it with fresh water. Many humidifiers do this with a timer, draining themselves every so many hours. Others use electrodes to measure the conductance of the water. When the mineral concentration becomes high, the humidifier controls sense the increased conductivity of the water.

When the mineral concentration in water becomes high enough, boiling the water produces foam, which in itself is undesirable. Some humidifiers that expose the surface of the boiling water to the air stream of the air conditioning system allow foam to be blown off of the water and into the ductwork, causing rust and mineral deposits to form. U.S. Pat. No. 6,078,729 by Kopel (Jun. 20, 2000) describes an electronic method of detecting the presence of foam in a humidifier by measuring electrical capacitance in the interior top region of the humidifier. As effective as this is, it relies on expensive electronic or even microprocessor controls. Also, by the time water has reached the “foaming” stage, the mineral concentration is beyond that which is required to produce precipitate, and mineral deposits are already forming. Furthermore, the conductivity and capacitance of the water may vary depending on the specific impurities present.

In any case, once a timer expires or a need for water renewal is otherwise detected, the humidifier is drained. Most humidifiers employ a solenoid valve that opens to allow the water to drain from the humidifier. If, however, minerals have formed and covered the drain opening, no draining occurs. Alternatively, if a piece of mineral or sediment becomes lodged in the valve, the valve may not close, and the humidifier will drain continuously.

U.S. Pat. No. 4,841,122 by Marton (Jun. 20, 1989) describes a humidifier with a valveless drain, wherein a drainhole at the bottom of the humidifier tank connects to a pipe that extends up the side of the humidifier to a height that defines the maximum water level in the humidifier under static conditions. When additional water is added to the tank, water “overflows” from the top of the pipe, and water from the lower extremity of the tank (which is presumably where any free-floating precipitate would settle) flows into the drainhole, continuing up the pipe and out of the humidifier, so long as water is being added. If, however, the drain becomes covered or clogged, the minimal water pressure created by the water level differential between the tank and the standpipe can do little to push the water out Also, the low velocity water flow is insufficient to keep debris from collecting in the bottom of the drainpipe.

### SUMMARY

In accordance with the present invention, a humidifier comprises a method for boiling water such that said water is in continuous rapid motion, a method for detecting the onset of foaming, and a method for purging the humidifier.

Objects and Advantages

The objects and advantages of the present invention include:

(a) To provide a humidifier that keeps water in its tank in constant, rapid motion, thereby reducing the deposit of minerals on internal components;

(b) To provide a humidifier that can detect the onset of foaming at an early stage;

(c) To provide a humidifier that can forcefully purge itself of water and minerals;

(d) To provide a humidifier that requires less periodic maintenance; and

(e) To provide a humidifier that is more reliable.

More objects and advantages will become apparent from a consideration of the ensuing description and drawings.

### DRAWING FIGURES

It should be noted here that the ensuing preferred embodiment drawings are of a humidifier that was built for the purpose of illustrating and explaining its operation. An actual marketable humidifier would be designed with all components nested as much as possible, for compactness.

FIGS. 1 and 2 show the preferred embodiment of the humidifier.

FIGS. 2A, 2B, and 2C show sectional views of the humidifier.

FIGS. 3 and 3A show an alternative embodiment of the humidifier tank and boiling chamber.

Reference Numerals In Drawings

| | | | | | |
|---|---|---|---|---|---|
| 10 | humidifier tank | 12 | boiling chamber | 14 | heating element |
| 16 | splash deflector | 18 | supports | 20 | water level tank |
| 22 | water level float | 24 | float switch | 26 | filling solenoid |
| | | | | | valve |
| 28 | “boilover” outlet | 30 | “boilover” trap | 32 | “boilover” float |
| 34 | float switch | 36 | siphon tank | 38 | nozzle |
| 40 | mouth of purging | 42 | purging pipe | 44 | purging solenoid |
| | pipe | | | | valve |
| 46 | drain outlet | 48 | water level | 50 | supports |
| 52 | fill spout | 54 | “boilover” tank | 56 | inverted trap |
| 58 | steam outlet | 60 | connecting pipe | | |

### DESCRIPTION

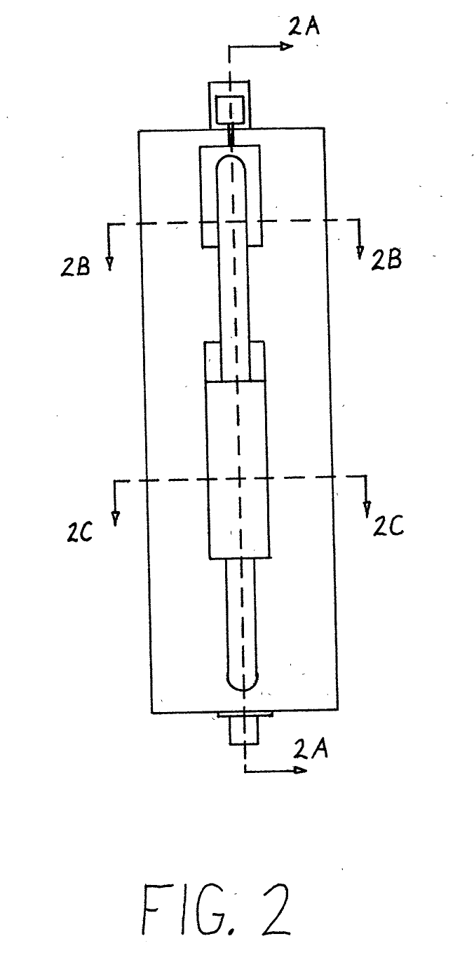

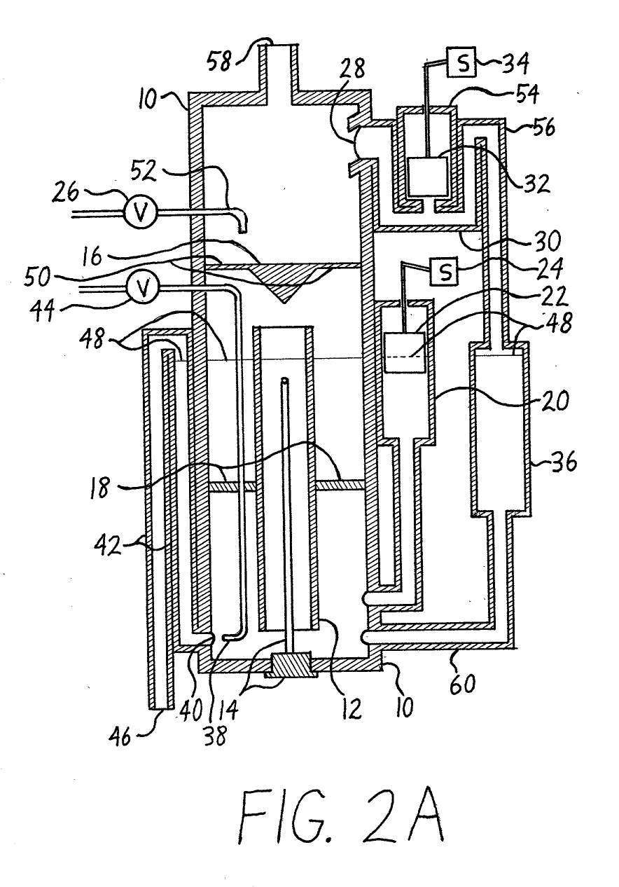

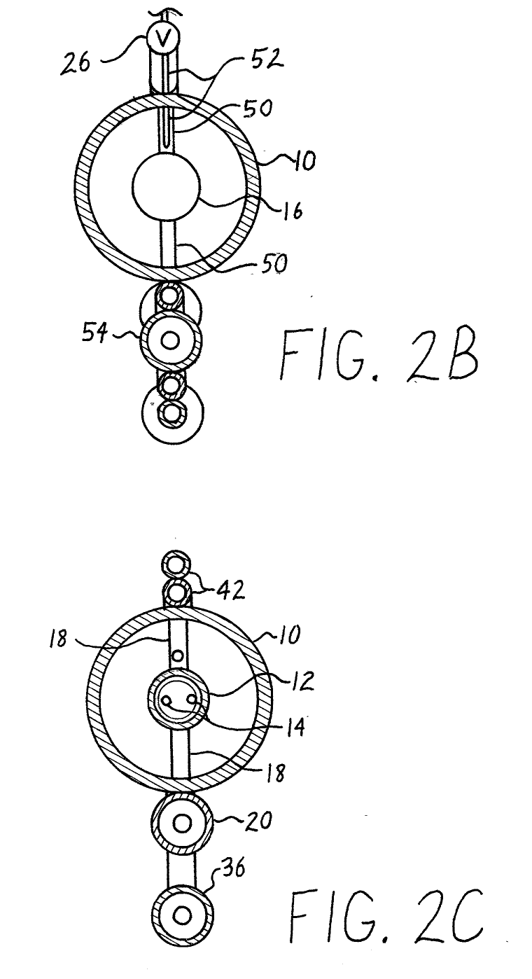

### FIGS. 2A, 2B and 2C

### Preferred Embodiment

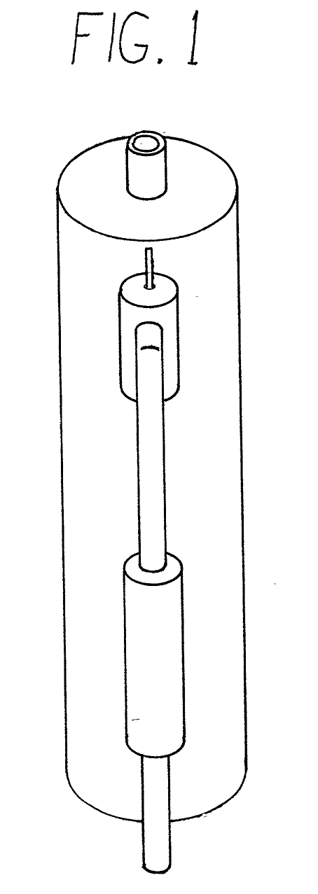

A preferred embodiment of the present invention is shown in FIG. 1, FIG. 2, and in the sectional FIGS. 2A, 2B, and 2C. A humidifier tank 10 has a threaded port in its base for the insertion of a heating element 14. A boiling chamber 12 is held in place by supports 18 such that the boiling chamber 12 extends above the heating element 14 and slightly above the water level 48, and the lower end of the boiling chamber 12 is held off of the base of the humidifier tank 10, and the boiling chamber 12 does not touch the heating element 14. An inverted cone, a splash deflector 16, is suspended over the top end of the boiling chamber 12 by supports 50. A water level tank 20 is disposed adjacent to the humidifier tank 10 and communicates with the same through a tube that exits the water level tank 20 at its bottom and enters the humidifier tank 10 near its bottom, below the water level 48. A water level float 22 and float switch 24 are disposed in the water level tank 20. A filling solenoid valve 26 is disposed on a fill spout 52 that protrudes into the humidifier tank 10. A boilover tank 54 is mounted on the humidifier tank 10 and communicates at its base with a boilover trap 30. The boilover trap 30 communicates on one end with a boilover outlet 28 and an inverted trap 56 on a second end. The boilover outlet 28 communicates with the humidifier tank 10 above the splash deflector 16. The inverted trap 56 communicates with a siphon tank 36 that begins at the same vertical level as the water level 48 and extends down a specific length, and is of a specific diameter. The siphon tank 36 reduces in diameter at its base to a specific smaller-diameter connecting pipe 60 which communicates with the humidifier tank 10 near its bottom. An inverted trap, a purging pipe 42, is disposed on the humidifier tank 10 such that its highest point extends slightly above the waterline 48. One end of the purging pipe 42 communicates with the humidifier tank 10 near its bottom, this point of communication being designated the mouth of purging pipe 40. The other end of the purging pipe 40 is open and extends down slightly below the bottom of the humidifier tank 10. The mouth of purging pipe 40 comprises the discharge portion of a jet pump. The jet portion of the jet pump comprises nozzle 38 disposed on a water tube, which nozzle is positioned appropriately for proper jet pump operation; the nozzle 38 being directed into the mouth of purging pipe 40. The water tube extends back from the nozzle 38, up and out of the humidifier tank 10 and is connected to purging solenoid valve 44. Domestic water piping is connected to solenoid valves 26 and 44. A steam outlet 58 is disposed at the top end of the humidifier tank. Electrical wires and necessary controls (not shown; prior art) are connected to float switches 24 and 34, solenoid valves 26 and 44, and heating element 14.

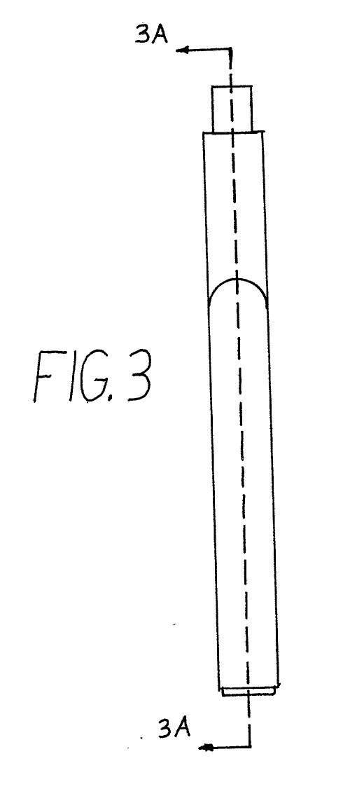

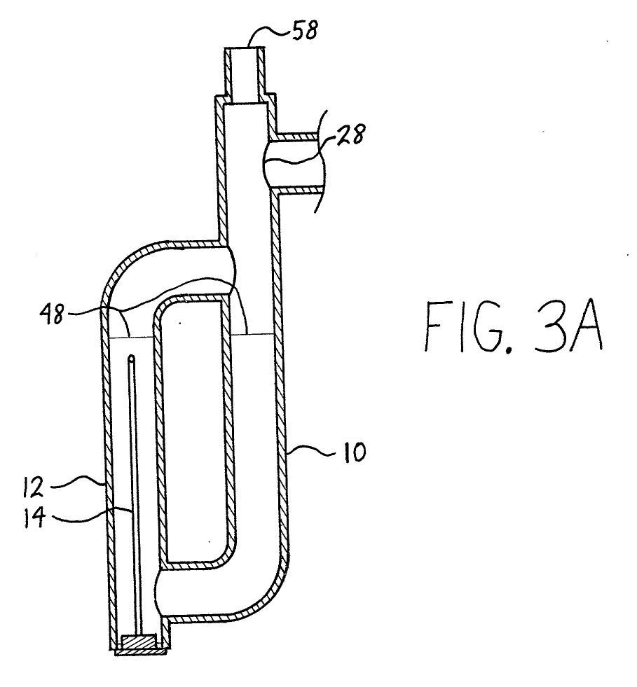

### FIG. 3

### Alternative Embodiment

An alternative embodiment of the humidifier is shown in FIG. 3. Instead of the concentric containers comprising the boiling chamber 12 and humidifier tank 10 of FIG. 2A, 2B and 2C, the humidifier is somewhat “O”-shaped; the left vertical riser serving as the boiling chamber 12, and the right vertical riser serving as the humidifier tank 10. The steam outlet 58 and boilover outlet 28 are located over the humidifier tank 10. The boilover trap and boilover tank, inverted trap, water level tank and siphon tank are not shown because these are unchanged from FIG. 2A.

### Operation

### FIGS. 2A, 2B, and 2C

The humidifier is turned on by a humidistat or other suitable control. The water level 48 in humidifier tank 10 is monitored by the water level tank 20, which communicates fluidly with the humidifier tank 10 such that the water level in both tanks is equal. When the water level drops in the water level tank 20, electrical controls connected to the float switch 24 de-energize the heating element 14 and energize the filling solenoid valve 26, filling the humidifier with water. When the water level float 22 rises to a specific height, the float switch 24 de-energizes the filling solenoid valve 26 and re-energizes the heating element 14. When the heating element 14 is energized it quickly heats up water in the boiling chamber 12 and steam is generated in seconds. As bubbles of steam form and rise to the top of the boiling chamber 12, they spill over into the humidifier tank 10. Water from the humidifier tank 10 flows up into the bottom of the boiling chamber 12 to keep the water levels equal. Gradually the water in the humidifier tank 10 heats up near to boiling as more and more water spills over into it. The bubble formation and spillover become more rapid, and after a few minutes water is circulating very quickly, up through the boiling chamber 12 and down through the humidifier tank 10. After several hours of operation, the mineral content of the water in the humidifier tank 10 increases to the point that the water's surface tension is sufficiently increased and the steam bubbles do not pop immediately when they spill over into the humidifier tank 10. Eventually these bubbles rise far enough up in the humidifier tank 10 that they rise above the splash deflector 16 and reach the boilover outlet 28. Bubbles that enter the boilover outlet 28 pop and their water collects in the boilover trap 30. The level in the humidifier tank to which the bubbles rise before popping increases very slowly. The boilover trap 30 and boilover tank 54 fill up quickly, before bubbles rise beyond the boilover outlet 28. The boilover float 32 rises in the boilover tank 54 and activates the float switch 34, which is connected to necessary wires and controls that activate a purge cycle. The filling solenoid valve 26 and the heating element 14 are disabled, and the purging solenoid valve 44 is energized. A jet stream of water is directed into the mouth of purging pipe 40. Water in the humidifier tank and any mineral precipitate or other foreign matter are sucked into the stream and pushed up the purging pipe 42, which effectively and quickly drains the humidifier tank 10. Water that leaves the drain outlet 46 has been tempered by the cold water from the jet stream, it is cooled significantly. As the water level in the humidifier tank 10 drops, the water level in the siphon tank 36 also drops, because the two tanks communicate fluidly through a connecting pipe 60. This creates a partial vacuum over the water in the siphon tank 36, which siphons the water out of the boilover trap 30 and the boilover tank 54. When the water level in the boilover trap 30 drops low enough that air can pass over the water in the bottom of said trap, the air breaks the siphon. Residual water in the pipes runs down into the boilover trap 30 and re-seals it fluidly. The boilover float 32 drops and de-activates the float switch 34. After a short time delay, the purging solenoid valve 44 is deactivated and the heating element 14 and filling solenoid valve 26 are re-enabled. The humidifier fills and begins heating again. An appropriate high-temperature limit device such as a fusible link may be located in the humidifier tank 10 to open the electrical circuit to the heating element 14 in the event the heating relay becomes stuck and energizes said heating element in a low-water or no-water condition. The purging cycle and subsequent fill cycle last less than a minute. Depending on the condition of the domestic water supply, a heating cycle can last 2 to 8 hours between purge cycles.

The jet pump pumps water and minerals out of the humidifier under pressure, unlike the “open drain” of U.S. Pat. No. 4,841,122 by Marton (Jun. 20, 1989) and does not require the water and minerals to pass through a drain valve as in prior art humidifiers. Mineral precipitate (if any were to form) is much more likely to be “free floating” because of the continuous violent motion of the water during boiling than in prior art humidifiers. The “foam” mentioned in U.S. Pat. No. 6,078,729 by Kopel (Jun. 20, 2000) occurs in boiling water of a much higher mineral concentration than the “boilover” bubbles of the present invention. Boiling water can precipitate minerals long before the water reaches a high enough mineral concentration to “foam,” but the present invention catches the water at a much earlier stage and pumps it out, starting over with fresh water before mineral precipitate can occur.

### Conclusion, Ramifications and Scope

Accordingly, the reader will see that the humidifier of this invention can be used to provide steam for humidification as well as for commercial, industrial and medical uses with a minimum of maintenance required. The advantages contributing to the low-maintenance feature of this humidifier include the following:

it provides a heating chamber that keeps the heated water in rapid motion, thereby limiting the precipitation of minerals onto internal parts;

it provides a heating chamber that produces steam quicker than prior-art humidifiers;

it permits the purging of the humidifier tank quickly and without the use of a drain valve;

it permits the purging of the humidifier tank without sending boiling hot water down the drain (which can harm some pipes); and

it permits the detection of undesirable mineral concentration in the boiling water.

Although the description above contains many specificities, these should not be construed as limiting the scope of the invention but as merely providing illustrations of some of the presently preferred embodiments of this invention. For example, the humidifier can have other shapes besides concentric or parallel cylinders. The humidifier may be made out of metal, plastic, or any suitable material. The humidifier may be molded, and/or made in pieces and assembled using glue, threaded joints, o-rings, or any suitable fastening system The humidifier may be made in many sizes to produce varying quantities of steam, and the steam generated may be intended for other uses besides humidification. The hardware of this invention can be controlled by any suitable control system, be it electro-mechanical, electronic, or microprocessor-based. Thus, the scope of this invention should be determined by the appended claims and their legal equivalents, rather than by the examples given.

I claim:

1. A container for a humidifier adapted to keep heated water in continuous motion, comprising:
A tank;
a designated normal operating level (or range) for water in said tank;
a boiling chamber comprising a means for boiling water disposed in a container, which container is horizontally aligned with said tank; said boiling chamber disposed adjacent to or contained within said tank; and
at least two means for fluid communication between said tank and said boiling chamber, one higher near the top of said boiling chamber, and one lower near the bottom of said boiling chamber, whereby heated, bubbly water rising in said boiling chamber spills into said humidifier tank, and water from said humidifier tank is drawn into the bottom of said boiling chamber, which water is heated and begins the cycle again, until said water is in a continuous, rapid motion, powered by convection and the upward motion of steam bubbles.

2. The container for a humidifier of claim I wherein said means for boiling water comprises a heater.

3. The container for a humidifier of claim 1 wherein said means for boiling water comprises two or more electrodes disposed in said boiling chamber to pass a heating current there through.

4. A method for emptying a humidifier tank using a jet pump comprising:
A purging pipe communicating with said humidifier tank near the bottom of said humidifier tank, which pipe extends up the side of said humidifier tank above the normal operating water level and terminating into a suitable drain; and
a domestic water supply pipe with a valve for water flow control, which pipe has a nozzle on its end disposed in said humidifier tank such that water flow from said nozzle is directed into the mouth of said purging pipe, whereby water is effectively “pumped” out of said humidifier tank through said purging pipe.

5. A method for generating a signal when the water in a humidifier tank contains an objectionable concentration of minerals by allowing said water to boil over into a separate chamber, comprising:
A port in said humidifier tank located above the normal operating water level,
a chamber that communicates with said port such that fluid exiting said tank through said port will accumulate in said chamber; and
controls for monitoring the amount of fluid in said chamber; whereby boilover is detected, indicating an undesirable concentration of minerals in said water.

6. The method of claim 5 wherein controls for monitoring the amount of fluid in said chamber comprise a float switch.

7. The method of claim 5 wherein controls for monitoring the amount of fluid in said chamber comprise two or more electrodes whereby the electrical characteristics of said water are measured.

8. The method of claim 5 wherein said chamber contains means for emptying itself.

9. The method of claim 8 wherein said means for emptying itself comprises a siphon pipe and means for initiating a siphon.
